(19) United States
(12) Patent Application Publication
(10) Pub. No.: US 2004/0168823 A1
(43) Pub. Date: Sep. 2, 2004

(54) Helical shed

(76) Inventors: David William Maute Thornley, Wiltshire (GB); Stephen Andrew Clift, Gloucestershire (GB); Alan Cook, Dorset (GB)

Correspondence Address: MYERS BIGEL SIBLEY & SAJOVEC, PO BOX 37428, RALEIGH, NC, 27627, US

(21) Appl. No.: 10/479,193

(22) PCT Filed: Jun. 25, 2002
(86) PCT No.: PCT/GB02/02922

(30) Foreign Application Priority Data
Jun. 29, 2001 (GB) 0116135.5

(51) Int. Cl. H01B 17/06

(52) U.S. Cl. 174/179

(57) ABSTRACT

A method of providing a shed (2) for a high-voltage insulator (1) comprises the steps of providing a substantially tubular substrate (3), providing an extruder (10) having an extruder head (11) defining an extrusion direction (A), using the extruder (10) to extrude the shed (2) and applying the shed (2) on the substrate (3) while rotating the substrate relative to the extruder head (11). According to the invention, the extrusion direction (A) substantially coincides with the longitudinal axis of the substrate (3), and the substrate (3) is fed through the extruder head (11).

The present invention relates to a helical shed, in particular for high-voltage applications. More in particular, the present invention relates to a method of providing a helical shed for a high-voltage insulator, the method comprising the steps of providing a substantially cylindrical substrate, providing an extruder having an extruder head defining an extrusion direction, using the extruder to extrude the shed and applying the shed on the substrate while rotating the substrate relative to the extruder head. A method of this kind is disclosed in U.S. Pat. No. 5,973,272 (Sediver).

High voltage components and devices, such as insulators, surge arresters and cable terminations may be provided with one or more sheds to increase the tracking length. Tracking is the well-known phenomenon of leakage currents flowing over the outer surface of the component. Lengthening the leakage path increases its resistance and thereby reduces the current and any surface deterioration caused by the leakage current. In this context, the term high voltage is understood to include voltages of more than 400V, in particular more than 1000V, and especially more than 5000V.

Traditionally, several individual ring-shaped sheds are arranged on the outer surface of a high-voltage component. The sheds may be heat-shrinkable, as disclosed in International Patent application WO 94/29886 (Raychem). The sheds may be combined into a single component, as disclosed in U.S. Pat. No. 5,389,742 (Raychem). In all these arrangements, the sheds constitute an array of approximately ring-shaped elements. In contrast, U.S. Pat. No. 4,833,278 (Hydro-Quebec) discloses an essentially helical shed made up of several joined shed segments. The above-mentioned U.S. Pat. No. 5,973,272 suggests to wind a single T-shaped shed element around a tube so as to provide an uninterrupted helical shed. The T-shaped element can be continuously extruded by an extruder the head of which is arranged at approximately a right-angle relative to the tube. The T-shaped shed element can be wound around the tube as it is being extruded, allowing a single component to be provided with a helical shed in one single process step. Although the process of U.S. Pat. No. 5,973,272 is very advantageous, the use of a T-shaped structure necessarily limits the bend radius of the helical shed. For this reason, this known process is not suitable for components having a relatively small diameter. In addition, the mutual sealing of adjacent windings of the T-shaped shed element cannot be guaranteed. As a result, dirt may accumulate in any gap between the windings and may decrease the surface resistance of the component, thereby causing an increased amount of tracking or water may penetrate the seal and cause electrical failure in the substrate. Another process, described in WO-A-99/10896, similarly uses transverse extrusion of the shed, resulting in bond lines between adjacent turns of the shed.

It is therefore an object of the present invention to eliminate the disadvantages of the Prior Art and to propose a method of providing a helical shed which is also suitable for high-voltage components having a relatively small diameter.

It is another object of the present invention to propose a method of providing a helical shed which allows a continuous production process over great lengths.

It is still another object of the present invention to propose a method of providing a helical shed which ensures an excellent sealing of the component.

It is yet another object of the present invention to propose a high-voltage component provided with a helical shed.

Accordingly, a method as defined in the preamble is according to the present invention characterised in that the extrusion direction substantially coincides with the longitudinal axis of the substrate, and in that the substrate is fed through the extruder head.

In spite of the apparently “wrong direction” of this longitudinal shed extrusion, compared with the known transverse extrusion methods, the present invention ingeniously and unexpectedly produces a satisfactory helical shed directly and continuously applied on the substrate. In addition, an integral sleeve covering the substrate can be co-extruded, thus environmentally sealing the substrate without bond lines between adjacent turns of the shed.

As the helical shed of the present invention is extruded as a curved part, it is possible to obtain much smaller diameters than with the wound sheds of the Prior Art which are extruded as straight parts.

In a preferred embodiment of the present invention the substrate is rotated while the extruder and extruder head are stationary. Alternatively, the extruder head could rotate while the substrate is (rotationally) stationary, or possibly both the substrate and the extruder head could be rotated. A stationary “cross head” type extruder is preferred.

The substrate may comprise a fibreglass rod, a plastic tube or the like. The shed material may comprise a silicone resin, a polyolefin and/or other suitable materials. The substrate may have a diameter of between 1 and 10 cm, preferably between 1.5 and 5 cm.

It is noted that a helical shed suitable for a high-voltage insulator is generally also suitable for other high-voltage devices and components, such as surge arresters, cable terminations, etc.

The present invention further provides a high-voltage component, such as a high-voltage insulator or a high-voltage surge arrester provided with a helical shed produced by the method defined above, and a sleeve comprising a helical shed produced by the method defined above.

The present invention will further be explained below with reference to the accompanying drawings, in which:

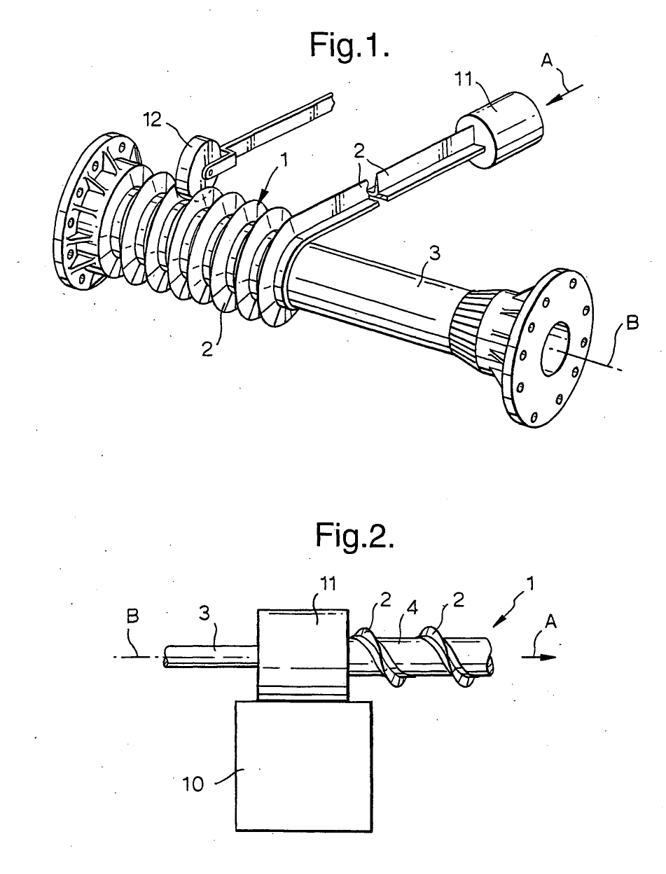

FIG. 1 schematically shows, in perspective, the production of a helical shed according to the Prior Art;

FIG. 2 schematically shows, in top view, the production of a helical shed according to the present invention; and

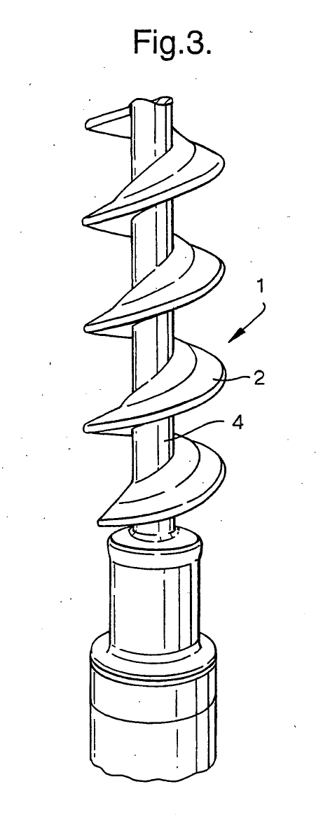

FIG. 3 shows a high-voltage insulator provided with a helical shed according to the present invention.

The method of producing a helical shed according to U.S. Pat. No. 5,973,272 is schematically shown in FIG. 1. An extruder head 11 produces a shed 2 in the form of a substantially T-shaped strip which is wound around a rotating substrate (high-voltage insulator) 3. The base of the strip is pressed onto the substrate by a pressure wheel 12. The adjacent windings of the base of the strip form a sleeve 4 which substantially covers the outer surface of the substrate 3.

The extruder head 11 is orientated such that the extrusion direction A is substantially perpendicular to the longitudinal direction and rotational axis B of the substrate 3. As can be seen from FIG. 1, the initially straight strip is bent around the substrate. Due to its T-shape, the bend radius is necessarily limited.

The method of producing a helical shed according to the present invention is schematically shown in FIG. 2. A substrate 3 is inserted into the head 11 of an extruder 10. The substrate, which may be a fibreglass rod, is rotated about its longitudinal axis B by rotating means (not shown) which may be integral with the extruder head 11 and which also advance the substrate 3 through the head 11. The extruder applies a continuous sleeve 4 onto the substrate 3, a helical shed 2 protruding from the sleeve 4. The resulting structure may be used as a high voltage insulator 1, such as shown in FIG. 3.

As shown in FIG. 2, the extrusion direction A coincides with the longitudinal axis B of the substrate. The combination of co-axial extrusion and rotation allow a helical shed to be readily applied in a single process step.

It is possible to use an auxiliary substrate having a smooth surface, such as a tube comprising TEFLON®, to first extrude the sleeve onto the auxiliary substrate. The sleeve can be removed from the auxiliary substrate and can then be applied on another substrate. The auxiliary substrate may be reusable.

It will therefore be understood by those skilled in the art that the present invention is not limited to the embodiments shown and that many additions and modifications are possible without departing from the scope of the present invention as defined in the appending claims.

1. Method of providing a helical shed (2) for a high-voltage insulator (1), the method comprising the steps of:
providing a substantially cylindrical substrate (3);
providing an extruder (10) having an extruder head (11) defining an extrusion direction (A);
using the extruder (10) to extrude the shed (2); and
applying the shed (2) on the substrate (3) while rotating the substrate relative to the extruder head (11),
characterised in that the extrusion direction (A) substantially coincides with the longitudinal axis of the substrate (3), and in that the substrate (3) is fed through the extruder head (11).

2. Method according to claim 1, wherein the substrate (3) is rotated.

3. Method according to claim 1 or 2, wherein the extruder head (11) is rotated.

4. Method according to any of the preceding claims, wherein the substrate (3) comprises a fibreglass rod.

5. Method according to any of the preceding claims, wherein the shed material comprises a silicone resin and/or a polyolefin.

6. Method according to any of the preceding claims, wherein the substrate (3) has a diameter of between 1 and 10 cm, preferably between 1.5 and 5 cm.

7. Method according to any of the preceding claims, wherein a continuous sleeve (4) substantially covering the substrate (3) is integrally extruded with the helical shed (2).

8. Method according to claim 7, wherein after extruding the sleeve (4) is removed from the substrate (3) and is applied on another substrate.

9. Method according to claim 8, wherein the substrate (3) is a rod or tube comprising TEFLON®.

10. High voltage component, comprising a helical shed (2) produced by the method according to any of the preceding claims.

11. High-voltage component according to claim 10, comprising a high-voltage insulator (1).

12. High voltage component according to claim 10, comprising a high-voltage surge arrester.

13. High-voltage component according to claim 10 or 11, comprising optical fibres for providing a data link.
